(19) United States
(12) Patent Application Publication
(10) Pub. No.: US 2009/0144720 A1
(43) Pub. Date: Jun. 4, 2009

(54) CLUSTER SOFTWARE UPGRADES

(75) Inventors: Ellard Thomas Roush, Burlingame, CA (US); Tirthankar Das, Bangalore (IN); Pramod Nandana, Bangalore (IN)

Correspondence Address: Ellard Thomas Roush, 1101 Laguna Ave., Apt. 204, Burlingame, CA, 94010, US

(73) Assignee: Sun Microsystems, Inc., Santa Clara, CA (US)

(21) Appl. No.: 11/959,022

(22) Filed: Dec. 18, 2007

(30) Foreign Application Priority Data
Nov. 30, 2007 (IN) 1624/KOL/2007

(51) Int. Cl. G06F 15/177

(52) U.S. Cl. 717/171

(57) ABSTRACT

A device, system, and method are directed towards upgrading software on a cluster. A cluster of nodes is divided into two partitions. The first partition is brought offline, and the software on each of its nodes is updated. The nodes are partially initialized and form an offline cluster, leaving uninitialized subsystems that share external resources or external communication. The second partition is brought offline. The nodes of the first partition complete their initialization and the first partition cluster is brought online. The nodes of the second partition are updated and join the first partition cluster. Quorum mechanisms are adjusted to allow each partition to operate as a cluster. The system thereby updates each node of the cluster with minimal time offline and without requiring software of different versions to intercommunicate.

### CROSS-REFERENCE TO RELATED APPLICATION

This application is a utility patent application based on Provisional Indian Patent Application No. 1624/KOL/2007 filed on Nov. 30, 2007, the benefit of which is hereby claimed under 35 U.S.C. § 119 and the disclosure of which is herein incorporated by reference in its entirety.

### FIELD OF THE INVENTION

The present invention relates generally to computer systems and, more particularly, but not exclusively to upgrades of software used across nodes of a cluster.

### BACKGROUND OF THE INVENTION

Clustering of computer systems is becoming an increasingly popular way for enterprises and large businesses to ensure greater availability to multiple users. Different types of clusters have evolved, including high availability (HA) clusters, high performance clusters, load balanced clusters, and the like. High Availability clusters are a class of tightly coupled distributed systems that provide high availability for applications typically by using hardware redundancy to recover from single points of failure. HA clusters typically include multiple nodes that interact with each other to provide users with various applications and system resources as a single entity. Each node typically runs a local operating system kernel and a portion of a cluster framework.

Generally, a cluster includes a number of computers that have some features in common. This may include providing redundant services or a common API, or including common software, such as operating system software or application software. A cluster of computers may be used, for example, to maintain a web site, where at least some of the computers act as web servers. A database cluster may implement a database. Clusters may have various other functions.

A typical cluster has multiple node computers that may be in communication with each other or with a network device. Each of the nodes includes an operating system (OS), cluster extensions, and various application software. The number of nodes, the interconnections, and the network structure may vary.

Any one or more of the OS, OS cluster extension, or application software may need to be upgraded or replaced from time to time. One of several techniques may be employed to upgrade software on nodes of a cluster. One such technique is to take the entire cluster out of service, make the desired software changes, and then bring the entire cluster back into service.

A second upgrading technique is referred to as a rolling upgrade. U.S. Patent Application 2004/0216133, by the applicant, describes a rolling upgrade as follows. One computer system in the cluster is taken out of service and new software installed. The computer system is then returned to service. The process is repeated for each computer system in the cluster. In this technique, during upgrading, different versions of the software may be in use at the same time.

Split-mode upgrading is a technique in which the cluster is divided into two sets of nodes. One set of nodes is taken out of service and new software is installed on each node. The second set of nodes is then taken out of service. The nodes of the first set are then booted and formed into an operational online cluster. The new software is then installed on the second set of nodes, which are then brought online and joined with the first set.

Each of the upgrading techniques described above has shortcomings with respect to providing high availability or complexity of implementation, development, or testing, as well as other disadvantages. Generally, it is desirable to employ improved techniques for changing software on a cluster. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a block diagram generally showing a cluster of computer systems in accordance with one embodiment of a system implementing the invention;

FIG. 2 is a block diagram generally showing an example of a cluster node in accordance with one embodiment of a system implementing the invention;

FIGS. 3A-G are block diagrams showing components of cluster nodes in varying stages of a process implementing an embodiment of the invention; FIGS. 4A-B are a logical flow diagram generally showing one embodiment of a method for updating cluster nodes; and

FIG. 5 is a block diagram generally showing a cluster node device that may be used to implement a node in one embodiment of the invention.

### DETAILED DESCRIPTION OF TEE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “network connection” refers to a collection of links and/or software elements that enable a computing device to communicate with another computing device over a network. One such network connection might be a TCP connection. TCP connections are virtual connections between two network nodes, and are typically established through a TCP handshake protocol. The TCP protocol is described in more detail in Request for Comments (RFC) 793, which is available through the Internet Engineering Task Force (IETF). A network connection “over” a particular path or link refers to a network connection that employs the specified path or link to establish and/or maintain a communication.

A “cluster” refers to a collection of computer systems, redundant resources distributed among computer systems, or “cluster nodes” that are managed as a single entity, and provide services that may reside on a single cluster node and be moved among the cluster nodes. A cluster may improve the availability of the services that it provides, by providing redundancy or moving services among the nodes to handle failures.

The term “cluster node,” or simply “node” refers to a computing element that is one logical part of a cluster. A node refers to a platform that hosts cluster software and applications. The platform may be a physical machine or a virtual machine. In one embodiment, a node platform might include a physical device, such as a computer, or the like, and an operating system. A cluster may refer to a collection of such nodes. A node may also be a virtual operating environment running on a physical device (i.e., a virtual node), and a cluster may refer to a collection of such virtual nodes. One or more software components enabled to execute on a physical device may be considered to be a node. A node might be a virtual machine or a physical machine. Examples of virtual cluster nodes include IBM™ virtual machines, Solaris™ Logical Domains (LDOMs), Xen™ domains, VMware™ “virtual machines” or the like. In one embodiment a node might be connected to other nodes within a network. As used herein, the term node refers to a physical node or a virtual node, unless clearly stated otherwise. The term cluster refers to a cluster of physical or virtual nodes, unless clearly stated otherwise. Two or more clusters may be collocated on the same set of physical nodes. In such a configuration, each cluster may be referred to as separate virtual clusters, or they may be referred to as two clusters that share hardware platforms.

As used herein, a cluster “resource” refers to any service, component, or class of components that may be provided on multiple cluster nodes. Resources might include instructions or data. Examples of resources include disk volumes, network addresses, software processes, file systems, databases, or the like. The term “resource group” refers to any group or collection of resources that run together on the same node. An “instance” of a resource refers to a specific component of the class of resource referred to. An instance of a resource may include one or more of an executing thread or process, data, an address, or a logical representation of a component.

As used herein, the term “dependency relationship” refers to an indication that one resource is to act in a particular manner based on the state of another resource. A resource that is dependent on the state of another resource is called a “dependent resource” or simply “dependent.” As used herein, a “dependee resource” or simply “dependee” is the resource upon which a dependent resource depends. Dependency relationships are generally directed and acyclic. In other words, the relationships between resources might form a directed acyclic graph (i.e., there are no cycles, and the relationships are one-way). A dependee resource may have one, two, or more corresponding dependent resources, and a dependent resource may have one, two, or more corresponding dependee resources.

As used herein, a “partition” of a cluster of nodes refers to a non-empty proper subset of the nodes. Reference to a first partition and a second partition refers to two non-overlapping partitions, unless stated otherwise.

Briefly stated, the present invention is directed toward a computer-based mechanism for updating software components on nodes of a cluster. Systems and method of the invention may include dividing a cluster of nodes into two partitions. The first partition is brought offline. Each node of the first partition is updated, which may be done in parallel. Initialization of each node may be divided in two parts. The first part of the initialization of the first partition nodes is performed while the second partition remains an operational online cluster. The first partition may be brought into an offline cluster. In one aspect of the invention, nodes of the first partition may establish membership. The second partition may be brought offline and updated. The first partition cluster may complete its initialization and be brought online. Nodes of the second partition cluster may be initialized and join the first partition cluster.

Mechanisms of the invention may further include determining the parts of the initialization and scheduling each part in order to maximize an amount of initialization that may be performed prior to bringing the second partition offline. In one aspect of the invention, subsystems that relate to a file system, external storage, network addresses, or applications may delay their initialization until after the second partition is brought offline. Other subsystems may be initialized prior to bringing the second partition offline. One aspect of the invention includes scheduling actions of initialization, bringing clusters offline or online, creating a cluster, or updating software in order to minimize down time and to avoid having nodes with different software versions communicate with each other or with external devices. In one implementation of the invention, initialization prior to bringing the second partition offline may include discovering all, or a substantial portion of, devices that are connected to each node of the first partition.

In one aspect of the invention, quorum mechanisms may be modified to enable a first partition to form a cluster, or to allow the second partition to operate as a cluster.

Aspects of the invention support high availability by techniques that reduce cluster service interruption. In one aspect of the invention, an online cluster may provide services during a time when components of an offline partition of the cluster are being updated, thereby reducing a time interval when services are not available.

### Illustrative Operating Environment

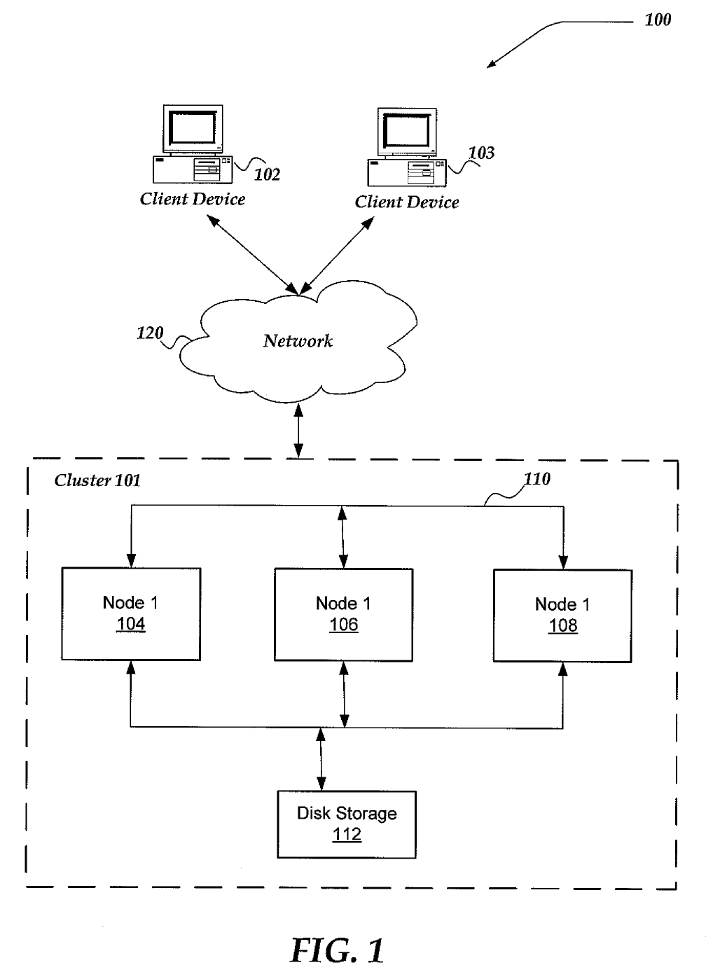

FIG. 1 illustrates one embodiment of an environment in which the invention might operate. However, not all of these components might be required to practice the invention, and variations in the arrangement and type of the components might be made without departing from the spirit or scope of the invention. As shown in the figure, system 100 includes client devices 102-103, network 120, and nodes 104, 106, and 108. As shown, nodes 104, 106, and 108 participate in cluster 101. In one embodiment, cluster 101 might be a high availability (HA) cluster, a high performance cluster, a load balanced cluster, or the like. Nodes 104, 106, and 108 may be virtual nodes or physical nodes.

Generally, client devices 102-103 might include virtually any computing device capable of connecting to another computing device to send and receive information, including web requests for information from a server device, or the like. The set of such devices might include devices that typically connect using a wired communications medium, such as personal computers, multiprocessor systems, microprocessor-based or programmable consumer electronics, network PCs, servers, or the like. The set of such devices might also include devices that typically connect using a wireless communications medium, such as cell phones, smart phones, radio frequency (RF) devices, infrared (IR) devices, integrated devices combining one or more of the preceding devices, or virtually any mobile device. Similarly, client devices 102-103 might be any device that is capable of connecting using a wired or wireless communication medium, such as a PDA, POCKET PC, wearable computer, or any other device that is equipped to communicate over a wired and/or wireless communication medium. Client devices 102-103 may include a mechanical device that is controlled, managed, monitored, or otherwise processed by the cluster or associated software.

Client devices 102-103 might further include a client application that is configured to manage various actions. Moreover, client devices 102-103 might also include a web browser application that is configured to enable an end-user to interact with other devices and applications over network 120.

Client devices 102-103 might communicate with network 120 employing a variety of network interfaces and associated communication protocols. Client devices 102-103 might, for example, use various dial-up mechanisms with a Serial Line IP (SLIP) protocol, Point-to-Point Protocol (PPP), any of a variety of Local Area Networks (LAN) including Ethernet, AppleTalk™, WiFi, Airport™, or the like. As such, client devices 102-103 might transfer data at a low transfer rate, with potentially high latencies. For example, client devices 102-103 might transfer data at about 14.4 to about 46 kbps, or potentially more. In another embodiment client devices 102-103 might employ a higher-speed cable, Digital Subscriber Line (DSL) modem, Integrated Services Digital Network (ISDN) interface, ISDN terminal adapter, or the like.

Network 120 is configured to couple client devices 102-103, with other network devices, such as cluster node devices corresponding to nodes 104, 106, 108, or the like. Network 120 is enabled to employ any form of computer readable media for communicating information from one electronic device to another. In one embodiment, network 120 might include the Internet, and might include local area networks (LANs), wide area networks (WANs), direct connections, such as through a universal serial bus (USB) port, other forms of computer-readable media, or any combination thereof. On an interconnected set of LANs, including those based on differing architectures and protocols, a router might act as a link between LANs, to enable messages to be sent from one to another. Also, communication links within LANs typically include twisted wire pair or coaxial cable, while communication links between networks might utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Network 120 might further employ a plurality of wireless access technologies including, but not limited to, 2nd (2G), 3rd (3G) generation radio access for cellular systems, Wireless-LAN, Wireless Router (WR) mesh, or the like. Access technologies, such as 2G, 3G, and future access networks might enable wide area coverage for network devices, such as client devices 102-103, or the like, with various degrees of mobility. For example, network 120 might enable a radio connection through a radio network access, such as Global System for Mobil communication (GSM), General Packet Radio Services (GPRS), Enhanced Data GSM Environment (EDGE), Wideband Code Division Multiple Access (WCDMA), or the like.

Furthermore, remote computers and other related electronic devices could be remotely connected to either LANs or WANs via a modem and temporary telephone link. In essence, network 120 includes any communication method by which information might travel between one network device and another network device.

Additionally, network 120 might include communication media that typically embodies computer-readable instructions, data structures, program modules, or other data in a modulated data signal, such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, or the like, in the signal. By way of example, communication media includes wired media, such as, but not limited to, twisted pair, coaxial cable, fiber optics, wave guides, or other wired media and wireless media, such as, but not limited to, acoustic, RE, infrared, or other wireless media.

As shown, cluster 101 includes nodes 104, 106, and 108. Cluster 101 is a collection of nodes that operate together to provide various services. As shown, nodes 104, 106, and 108 are coupled to each other by one or more interconnects 110, which may be include wired or wireless connections or a combination thereof. Cluster 101 further includes one or more storage devices 112 that are shared by the nodes or a subset thereof.

When cluster 101 is booted (e.g., the nodes of cluster 101 are initially started) and following any type of failure that takes a resource group offline (i.e., the resource group is no longer running on the node), at least one resource group is started on one or more available nodes to make at least one resource available to clients (e.g., client devices 102-103 over network 120).

Resources in resource groups might be dependent on resources in the same resource group or another resource group. Resource dependencies might include components (e.g., properties, associations) that describe the dependencies. For example, typical components might include the category of the dependency, the location of the dependency, the type of dependency, other qualifiers, or the like. Moreover, these components might be further defined with specific details (e.g., specific locations, types, or categories), which might add to the complexity of the dependencies. In one embodiment, clustering software uses an algorithm to satisfy all the dependencies when activating a particular resource group on a given node. If this is not possible, services of the resource group might remain offline.

Communication media typically embodies computer-readable instructions, data structures, program modules, or other data in a modulated data signal, such as a carrier wave, data signal, or other transport mechanism, and includes any information delivery media. The terms “modulated data signal,” and “carrier-wave signal” includes a signal that has one or more of its characteristics set or changed in such a manner as to encode information, instructions, data, and the like, in the signal. By way of example, communication media include wired media, such as twisted pair, coaxial cable, fiber optics, wave guides, and other wired media and wireless media, such as acoustic, RF, infrared, and other wireless media.

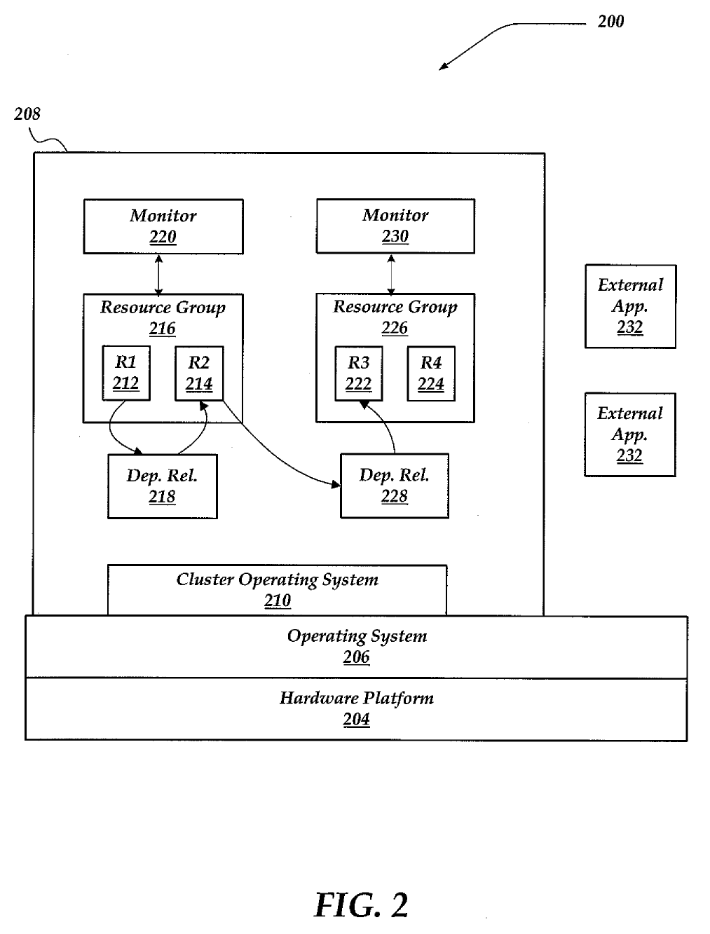

FIG. 2 shows a system diagram of details of components of a cluster node in accordance with one embodiment of the invention. System 200, or a portion thereof may correspond to any one of nodes 104, 106, or 108 of FIG. 1.

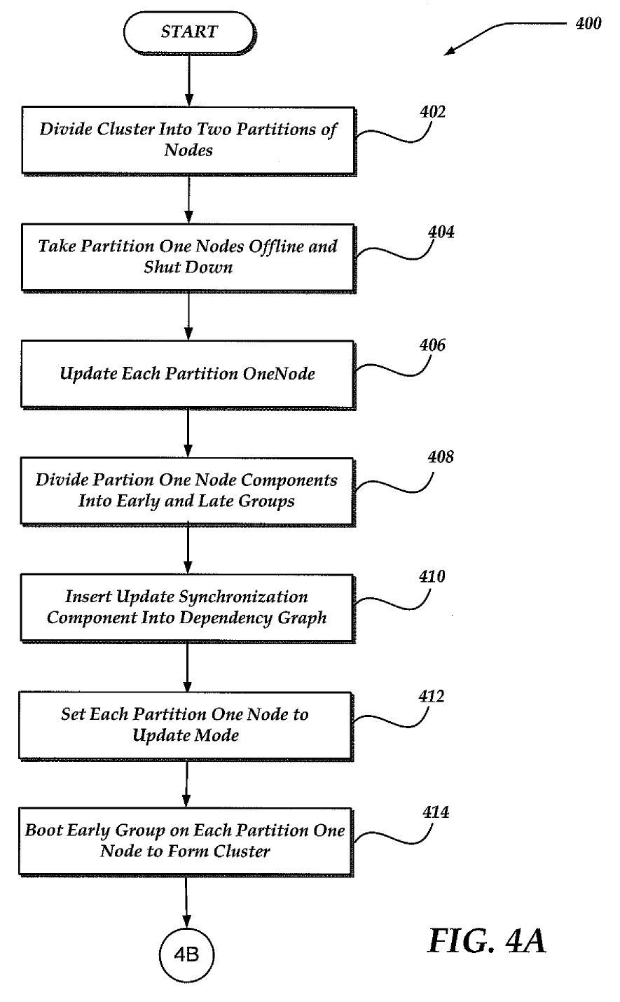

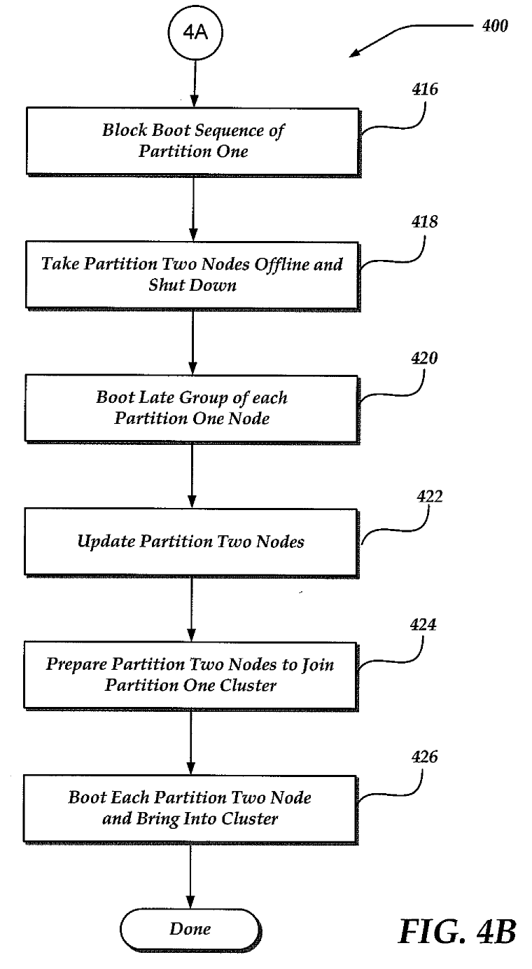

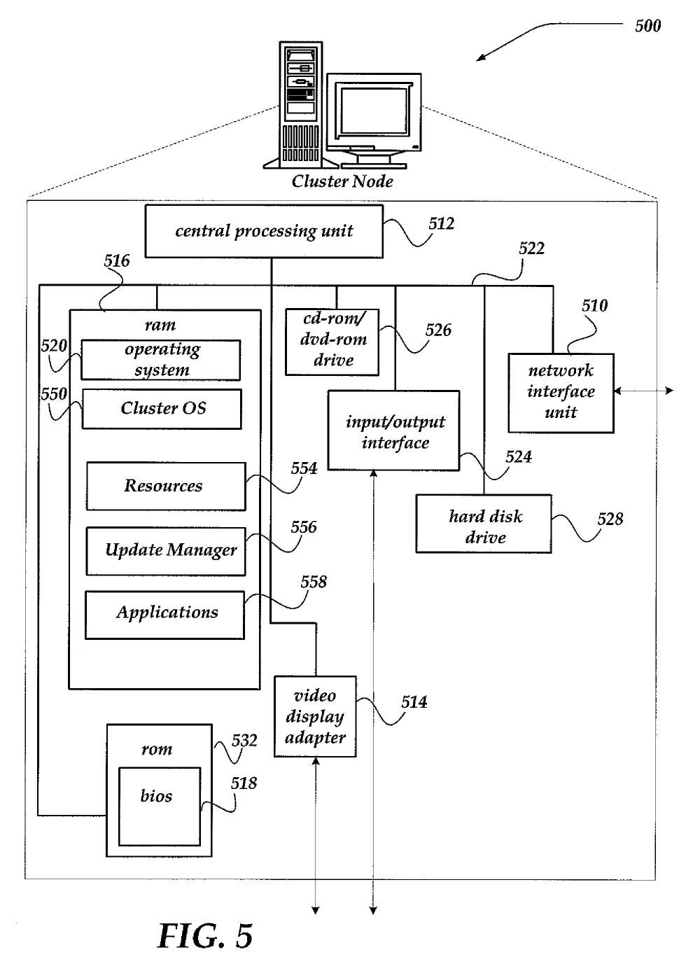

As shown, system 200 includes a hardware platform 204. Hardware platform may be the hardware of any type of computing device capable of connecting to another computing device to send and receive information. This may include a server, a personal computer, or other type of computing system. FIG. 5 illustrates a cluster node device that may include the hardware platform 204 of system 200.

System 200 further includes an operating system 206. Operating system 206 may be any general purpose operating system, such as Unix, Linux, Windows, or the like. Operating system 206 may also be a special purpose operating system designed for particular functionality.

System 200 further includes a cluster operating system (OS) 210. In one embodiment, cluster OS 210 communicates with the hardware platform 204 through operating system 206, though in some embodiments cluster OS 210 may at least partially communicate with hardware platform 204 directly or through another intermediary component. Cluster OS 210 may include one or more extensions that add or enhance functionality of the cluster framework. As used herein, reference to a cluster OS includes extensions, unless stated otherwise. Cluster OS 210 includes much of the logic of the cluster framework that maintains the availability of resources and services. In one embodiment, at least part of the cluster operating system is implemented as a set of software components, such as Common Object Request Broker Architecture (CORBA) objects; however, other architectures or technologies may be used in various implementations.

As shown, system 200 may have one or more resource groups that run on the node. For example, system 200 includes resource group 216, which includes resources R1 (212) and R2 (214), and resource group 226, which includes resources R3 (222) and R4 (224). A resource group may provide one or more services to users of the cluster.

Resource groups may also be associated with at least one monitor, such as monitor 220 to monitor the resources/resource groups. In one embodiment, a monitor may be a separate process that monitors the activity of the services provided by each resource. As shown, monitor 220 monitors the resource group 216 and resources R1 212 and R2 214; monitor 230 monitors the resource group 226 and resources R3 222 and R4 224. A monitor may initiate a failover of its associated resource group in response to one of the services within the group failing, degrading, or becoming inaccessible. A monitor may inform a resource group manager (not shown) that an event or status change has occurred, causing the resource group manager to take one or more resources offline, to place the resource online, or other control functions. In one embodiment, a resource group manager is a system service that coordinates the starting, stopping, and monitoring of resource groups.

One or more dependency relationships may be associated with two resources on a node. The two resources corresponding to a dependency relationship may belong to the same resource group or to two different resource groups. As shown, relationship 218 declares a relationship for R1 212 and R2 214; relationship 228 declares a relationship for R2 214 and R3 222. For example, relationship 218 may specify that R1 212 is dependent on R2 214; relationship 228 may specify that R2 214 is dependent on R3 222. Though only two resources are illustrated in each of the resource groups 216 and 226, a resource group may have fewer or more resources, and zero or more relationships. A relationship may exist for any pair of resources. A node may have zero, one, or more resource groups.

In one embodiment, each of resource groups 216 and 226 might include one or more properties, such as a nodelist (a list of nodes upon which the resource group may run), a resource group name, a resource group description, a “failover” policy (e.g., a policy that states whether to restart a resource group on a different node once the resource group has failed on the current node), or the like.

Resources, such as those in resource groups 216 or 226, might be brought online or offline under varying circumstances. A resource group might be brought online when booting/starting servers in an associated cluster, when a user or a policy determines that a resource is to be started on a node, upon restarting of a resource, or the like. Resource groups might be brought offline when a user or a policy, upon restart, failover, or the like, shuts down, an associated cluster.

In one embodiment, a particular monitor, such as monitor 220 or 230 might initiate a failover of its associated resource group when one of the services within the resource group fails or cannot make itself available to users. As shown, each resource and/or resource group might be associated with a monitor that might be a separate process that monitors the activity of the service(s) provided by the resource. When the resource group is activated on a node, a resource and a monitor for each resource in each resource group may also be activated. A failover is typically invoked if one of the monitors detects that the service provided by a particular resource (within the resource group) is unhealthy, has failed, or has hung, the service provided is showing performance degradation, or the like. In one embodiment, a monitor may request a resource group manager to initiate a fail-over. In order to restore the health of the service, the monitor might initiate a failover to restart the resource group on a different node. Thus, the failover might take a resource offline and then attempt to place the resource back online.

In one embodiment, one or more dependency relationships 218 or 228 might specify which resource is dependent on which other resource, when dependency relationships might be activated and what actions might take place if the relationships are activated (i.e., time based), and on which node the resource might be brought online or offline (i.e., locality based). Accordingly, a dependency relationship might have several characteristics (e.g., time based qualifiers, locality based qualifiers) that qualify the dependency relationship.

A dependency relationship 218 or 228 might indicate that a dependee is to be brought online (e.g., started or restarted) before a corresponding dependent. The dependent and the dependee might be in the same group or different groups. For example, upon booting of a cluster node containing cluster software 208, a dependent in resource group 216 might not start until a dependee in resource group 226 has started. Dependency relationships 218 or 228 might indicate that a dependee should not be brought offline until the dependent is brought offline. For example, the dependee resource R3 222 in resource group 226 should not be brought offline (e.g., stopped, restarted), until the dependent resource R2 214 in resource group 216 is brought offline. In one embodiment, the cluster framework maintains dependency relationships, and performs actions to facilitate the enforcement of dependency relationships.

As shown, system 200 includes two applications 232. These applications may or may not be a component of the cluster software, and do not necessarily conform to the conventions of a cluster component, though they may execute on the operating system 206 and on the hardware platform 204. Applications 232 may use one or more of resources 212-214 or 222-224.

System 200 includes a set of software components referred to as cluster software 208. Thus, cluster software 208 may include cluster OS 210, resource groups 216 and 226, monitors 220 and 230, dependencies 218 and 228, and other components not illustrated. In some, but not all, uses, cluster software may additionally include applications executing on the same platform as the cluster node, for example applications 232.

As used herein, the term “cluster framework” refers to the collection of cluster operating system, cluster tools, cluster data, and cluster components on all nodes of a cluster that are used to implement a cluster. A cluster framework may also include development tools or code libraries for use in developing applications or enabling applications to operate in a cluster. A cluster framework may include an APT that contains method calls or other mechanisms for providing data or commands to the framework. In one embodiment, a cluster framework API may be invoked by a cluster resource to query or change a resource state.

### Generalized Operation

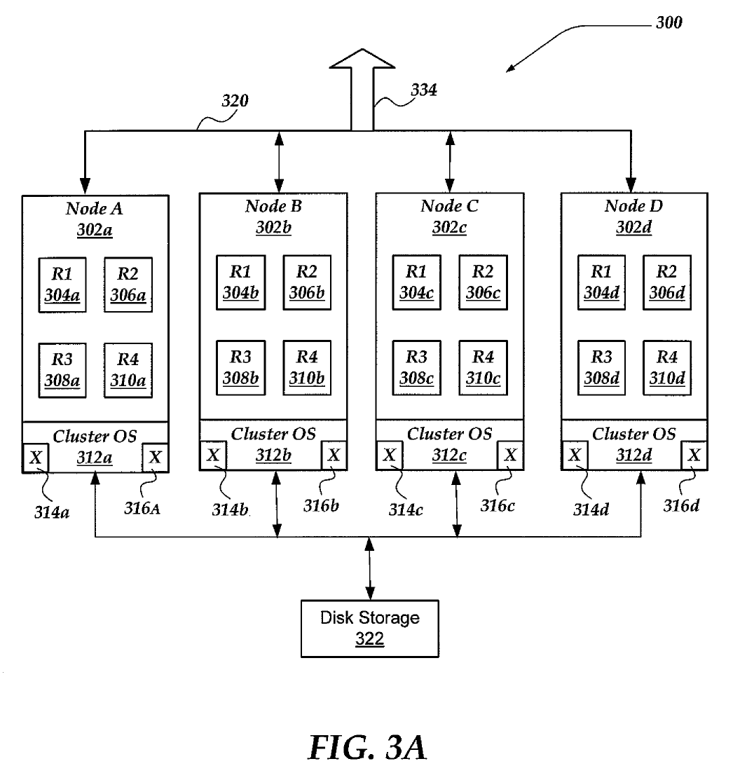

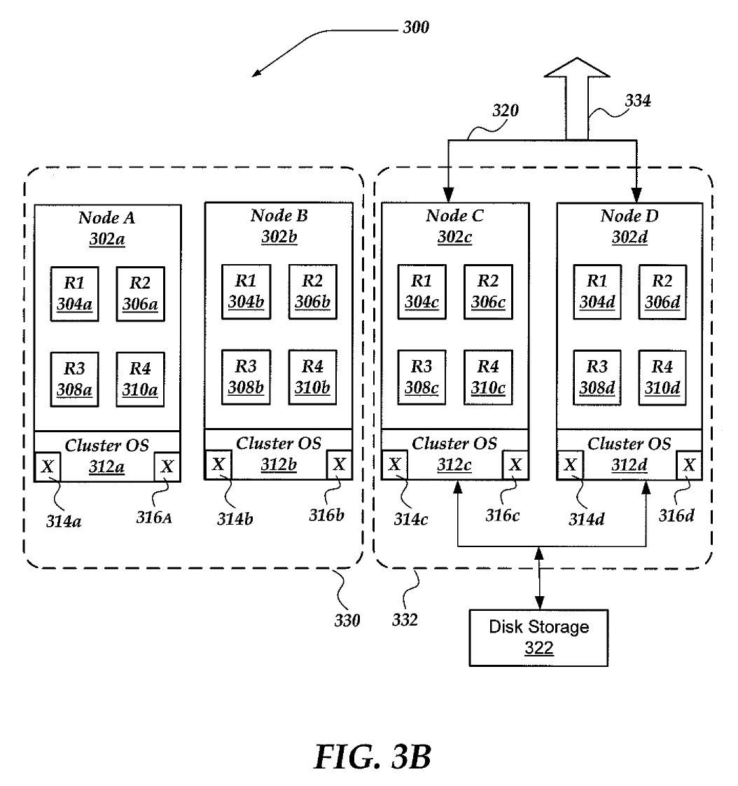

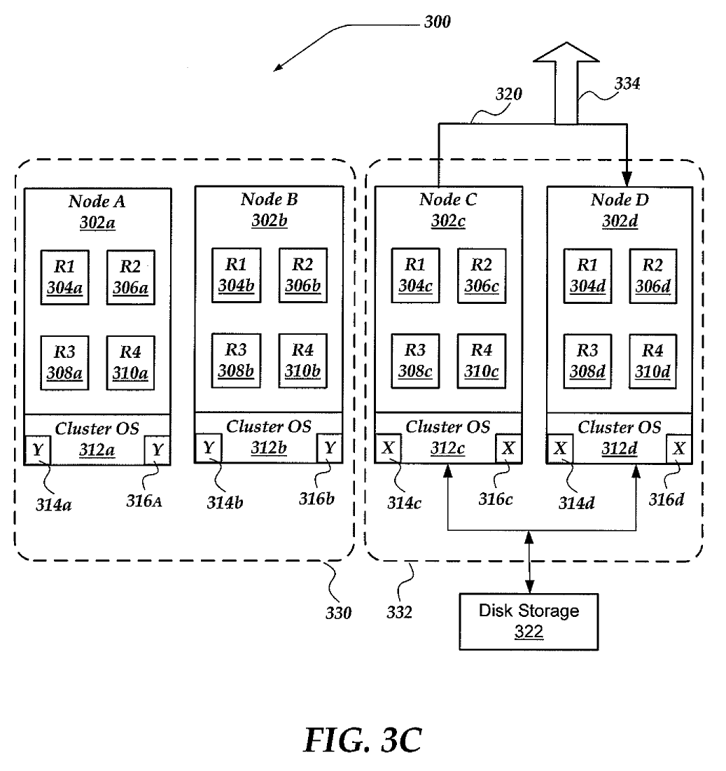

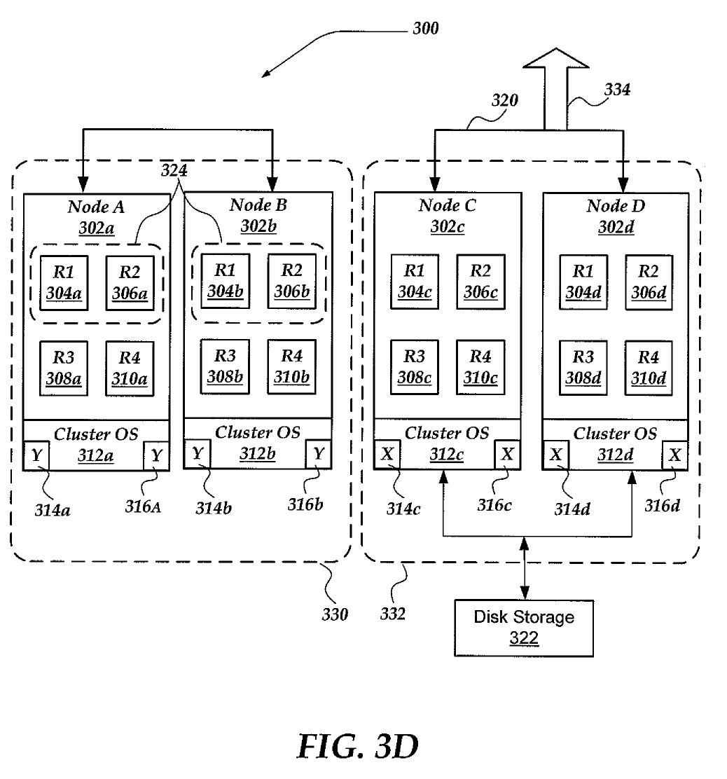

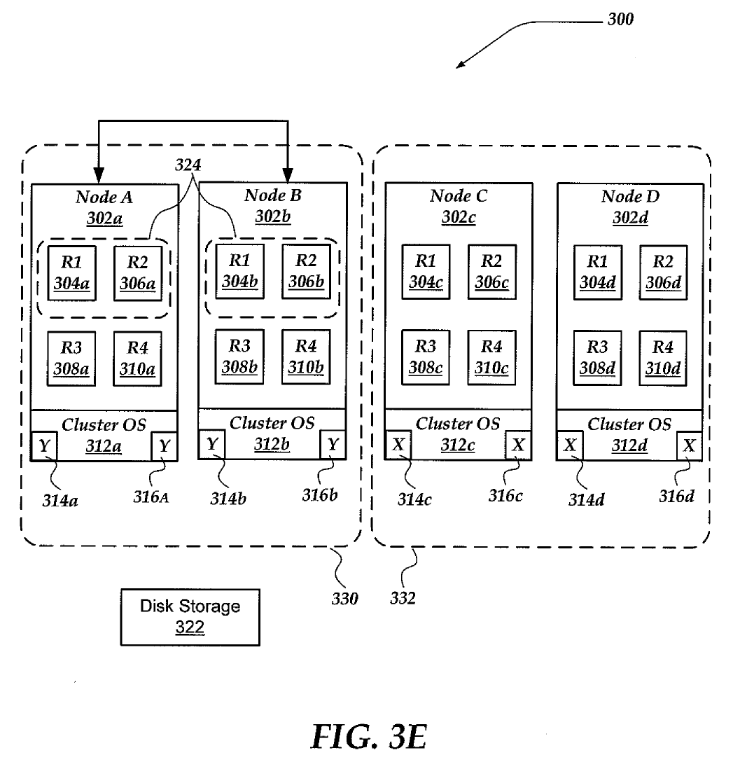

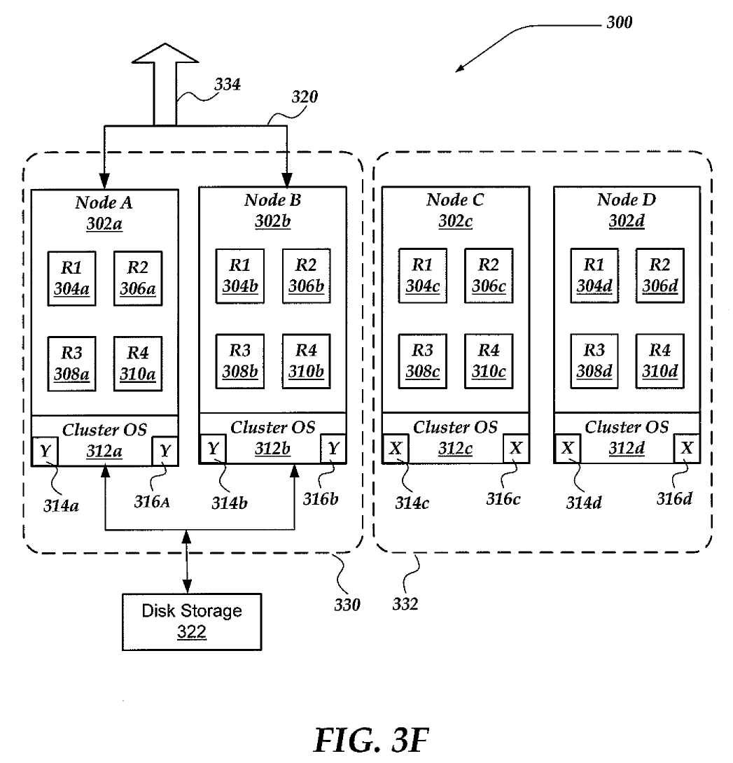

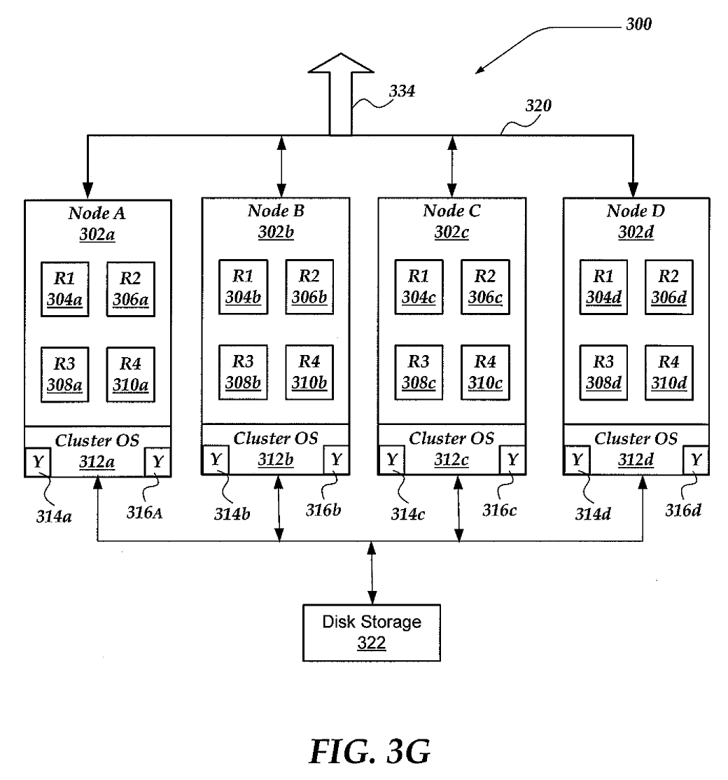

FIGS. 3A-G show selected components of cluster nodes in varying stages of a process implementing an embodiment of the invention. Though the ordering of FIGS. 3A-G illustrate one sequence of events, in other implementations, the ordering of events may vary from this sequence. Each of the nodes illustrated in FIGS. 3A-G may include additional components illustrated in FIG. 2, though these are omitted from FIGS. 3A-G for simplicity.

FIG. 3A shows a system 300 including a cluster of nodes. Each of node A 302a, node B 302b, node C 302c, and node D 302d are connected to each other via one or more interconnects 320. Each of nodes A-D 302a-d may communicate with one or more shared storage devices, such as disk storage 322. In some configurations, one or more storage devices may be shared by a subset of the nodes of the cluster. Arrow 334 indicates that the cluster is communicating with, and providing services to, external clients.

Each of nodes A-D 302a-302d includes an instance of a cluster operating system 312a-d. A cluster operating system may include any number of components, each component including instructions, data, or a combination thereof. As illustrated, cluster OS 312a-d include respective components 314a-d and 316a-d. Each of these components is labeled with an “X” to indicate that this is a version of the component prior to updating.

As illustrated, each of nodes A-D 302a-d includes four resource components R1 304a-d, R2 306a-d, R3 308a-d, and R4 310a-d. On each node, the resources may have associated components or processes and be arranged in resource groups not illustrated in FIGS. 3A-G.

FIG. 3A illustrates a cluster that is online, prior to beginning an update process. As used herein, an “online cluster” refers to a cluster that is operational to provide services to one or more clients. Typically, an online cluster accesses devices that are shared by nodes of the cluster, though an online cluster may be configured without shared devices. FIGS. 3B-G illustrate the cluster in later stages of an update process, in accordance with an embodiment of the invention. Components in FIGS. 3B-G having like numbers to FIG. 3A refer to the same component, albeit in a different state, except where stated otherwise.

A process of updating a cluster is now discussed with reference to FIGS. 3A-G and FIGS. 4A-B. FIGS. 4A-B are a flow diagram of a process 400 for updating components of a cluster. After a start block, the process 400 proceeds to block 402, where nodes of the cluster are partitioned into two sets, referred to herein as the first partition and the second partition. In the illustration of FIG. 3B, the first partition of nodes, indicated by dotted line 330 includes node A 302a and node B 302b; the second partition of nodes, indicated by dotted line 332 includes node C 302c and node D 302d.

The process 400 may proceed to block 404, where nodes of the first partition 330 are taken off line and halted. In one implementation, halting each node may include rebooting or otherwise transforming the node into a “non-cluster mode,” in which the node does not access, or does not write to, the disk storage 322 and does not provide services externally. As used herein, taking a node “offline” refers to a state wherein the node is not communicative with external clients or otherwise does not provide services to external clients. A cluster of nodes that is “offline” may communicate with each other, but do not provide services to external clients. Taking a node or cluster offline refers to an action of putting each node or the cluster in a state of being offline. Taking a node offline may also include disabling access to, or disabling writing to, one or more shared devices. FIG. 3B illustrates a stage of the cluster in which the second partition 332 having nodes C-D 302c-d are in the online cluster and the first partition 330 having nodes A-B 302a-b are offline. Arrow 334 indicates that the second partition cluster is communicating with, and providing services to, external clients.

The process 400 may proceed to block 406, where components of each node of the first partition may be updated. As used herein, the term “updating” a cluster node or a component, or an “update” refer to one or more changes that may be performed in a number of ways. Updating may include adding or enabling software instructions or data, deleting or disabling software components, instructions or data, replacing software components, instructions or data, modifying data formats, moving instructions or data to a different location, or the like. An update may include a newer version of a component, software or instructions than that currently in use. It may include changing to an older version, or simply a different version. It may refer to a change in configuration, architecture, API, or various other changes. Updating a cluster node may refer to updating operating system software, file system software, volume manager software, cluster operating system or other cluster software, application software, any other software component, or any combination thereof. In one embodiment, updating a node may include adding, enabling, replacing, disabling, configuring, modifying, or removing a hardware component. Updating a cluster node may also refer to updating of applications residing on nodes of the cluster. For simplicity of discussion, a version that is employed prior to an update is referred to as the “old” version, and the version that is employed after an update is referred to as the “new” version, though in some uses of the invention, a “new” version may be part of a roll back to a previously used or previously implemented version.

In FIG. 3C, components 314a-b of respective nodes A-B 302a-b are shown with the symbol “Y” representing an update of the component from the previous state of “X,” Updating components may include one or more actions, each of which may be automated or include manual action by an administrator. In one implementation, mechanisms of the invention perform automatic updating and then pause to allow an administrator to perform manual updating actions. In one implementation, updating includes converting persistent information on each node to conform to requirements of an updated version. This may include transforming data formats, locations, values, or the like, or adding, deleting, or replacing data.

The process 400 may flow to block 408, where resources, subsystems, or other components of each node are divided into two groups, referred to herein as an early group and a late group. In one implementation, the late group includes components that relate to sharing external resources or communications, such as disk storage 322, IP or other network addresses, file systems, or applications that communicate with external clients. This may include, for example, a volume manager, which is a component that manages multiple volumes and may write to shared external storage. The late group may also include components that are dependent upon other components that are in the late group. The early group includes components not in the late group. In FIG. 3D, the late group is indicated by the dotted line 324. Thus, in the configuration of FIG. 3D, resources R1 304a-b and R2 306a-b of the first partition 330 are in the late group 324, and remaining components of each node are in the early group. The cluster OS 312 may be considered to be in the early group. In one implementation, at least a portion of the actions of block 408 may be performed prior to actions of block 404 or 402. Specifications of the early or late groups may be stored for subsequent use by the process 400.

In one implementation, it may be desirable to employ a synchronization point to divide initialization of a component, A synchronization point may be specified or inserted at a point in the logic of a component initialization, such that initialization up to that point is performed during the early initialization, and initialization following the synchronization point is performed during the late initialization. During execution, at the synchronization point, the component, or the initialization of the component, may block until a later time when the block is removed and the component may proceed. A synchronization point may be implemented by using semaphores and signals, invoking an object, such as a CORBA object, that blocks, or other mechanisms for blocking.

The process 400 may flow to block 410, where a component, referred to herein as an update synchronization component, may be inserted into a directed graph of dependency relationships for the resources of each node. In one embodiment, the update synchronization component is inserted at a point that distinguishes the late group from the early group, such that members of the late group are directly or indirectly dependent on the update synchronization component. Insertion of the update synchronization component at this point provides a point during a booting process where mechanisms of the invention may interrupt booting to perform actions discussed herein.

The process 400 may flow to block 412, where each node of the first partition is set to an update mode. The update mode may include modifying node configuration data or instructions to provide for changes in the way nodes function. For example, one modification includes modifying a mechanism for indicating how nodes behave when other nodes fail communication with one or more other nodes fails, or when one or more nodes must recover from a change of cluster state. This may include a mechanism of quorum voting, in which one or more nodes determines whether they are to be a cluster. It may include a mechanism using a quorum device, such as an external storage device, that assists in indicating whether one or more nodes may be a cluster. A quorum device is an external device, such as an external storage device, that contributes votes that are used to establish a quorum, where a group of one or more nodes establishes a quorum in order to operate as a cluster. One use of a quorum device is to avoid having subclusters that conflict with each other when accessing shared resources, which may cause data corruption or duplicate network addresses.

In one implementation, a setting of update mode may include configuring a quorum device or otherwise altering quorum configuration data to enable nodes of the first partition 330 to form a cluster without requiring communication with the second partition 332. In one implementation, altering quorum configuration data includes modifications to enable a node of the first partition to have sufficient quorum votes to enable forming a cluster without access to a quorum device. This may include changing a weighting of quorum votes, providing multiple votes to a single node, or the like.

Another mechanism that may be modified when in update mode is referred to as “failure fencing,” or simply “fencing.” Generally, fencing limits node access to multihost devices by physically preventing access to shared storage, such as disks. When a node leaves a cluster, fencing prevents the node from accessing shared disks. In one implementation, a cluster may use SCSI disk reservations to implement fencing. In one embodiment, the process 400 may turn off fencing, in order to allow nodes of the first partition to access the shared disks. This may occur as part of the actions of block 412, or at another time, such as part of the actions of block 414.

Process 400 may flow to block 414, where the system partially boots, or partially reboots, nodes of the first partition 330 into a cluster. This action includes initializing resources or components of the first group on each node of the first partition 330. In FIG. 3D, this includes, on each of nodes A-B 302a-b, initializing the cluster OS 312a-b, resources R3 308a-b and R4 310a-b, and other components that are not in group B 324. Each node may perform initialization actions including communicating with other nodes of the first partition to form a cluster, though this cluster is not yet online. It may be said that the nodes of the first partition establish membership and are each aware of the other nodes of the partition. Thus, one aspect of the process 400 includes scheduling initialization actions for various components of each node, in order to allow for a sequence of initialization in accordance with the invention. As discussed below, in one implementation, the partial initialization performed at block 414 may be based on whether the associated subsystem or component accesses or writes to an external shared resource, such as disk storage 322, or whether the initialization enables communication with external clients.

In one implementation, the partial initialization performed at block 414 may include operating system level device initialization, such as discovering devices that are connected to each node of the partition. In one implementation, this may include discovering all, or substantially all, such connected devices.

FIG. 3D illustrates a state wherein the first partition 330 has partially initialized and formed an offline cluster, while the second partition 332 continues to perform as the online cluster, providing external services to clients. In one implementation, the system may modify a communication token associated with each node of the first partition, so that nodes of the first partition do not communicate with nodes of the second partition. In one implementation, this may be performed by incrementing a communication version number for the first partition nodes. By disabling communication between the first partition and the second partition, different versions of the software may avoid inter-communication. More specifically, a first node having a first version of software may avoid communicating with a second node having a different version of the software. An updated component on the first node does not need to interact with a corresponding non-updated component on the second node. Also, another component, which may or may not be updated, may avoid interacting with both an updated component and a non-updated component.

Process 400 may flow to block 416 in FIG. 4B, where the booting sequence may be automatically blocked. In one implementation, blocking, or a portion thereof, may occur as a result of the update synchronization component inserted into the dependency graph for components on each node, such that components of the late group, which depend upon the update synchronization component, are blocked from proceeding. In one implementation, at least a portion of the blocking is performed as a result of one or more synchronization points inserted into the booting sequence for one or more components.

Process 400 may flow to block 418, where the second partition is taken offline and shut down. In one implementation, the cluster of the first partition may send a command to the second partition to shut down. The first partition cluster may monitor the shutdown sequence to determine a point at which the first partition may continue its initialization sequence. In one implementation, this may occur when the second partition has ceased I/O, such that it is no longer providing external services or accessing shared storage. Thus, part of the shutdown of the second partition may proceed concurrently with the remaining initialization of the first partition, as represented by block 420. FIG. 3E illustrates a state at this stage, where there is no online cluster communicating with, or providing services to, external clients.

At block 420, the late group on each node of the first partition may begin, or continue, the booting process. In one embodiment, the second group includes the storage subsystem, the file system, the IP address subsystem, and applications. In various embodiments, this portion of the booting process includes importing one or more storage volumes, mounting one or more file systems, advertising one or more IP addresses for network communications, starting one or more applications, or any combination thereof. These actions enable each node to access and write to external storage volumes, such as disk storage 322. By delaying this portion of the booting process, mechanisms of the invention may avoid conflicts, corruption, or other problems that may occur if two partitions of a cluster operate as separate clusters, such as conflicting access to an external storage device, conflicting network addressing, or corruption of distributed configuration data. Thus, one aspect of the invention includes scheduling booting or initialization of these subsystems, thereby maintaining system integrity. In one embodiment, none of the actions of importing storage volumes, mounting file systems, advertising IP addresses, or starting applications are performed. In one embodiment, a cluster may have limited or no external access. The cluster may be accessed from a directly connected terminal. In one embodiment, a cluster may read or write to a network attached storage (NAS) device that is external to the cluster. The actions of block 420 may include initialization to enable access to one or more NAS devices. When this portion of the booting is complete, or substantially complete, the first partition operates as an operational online cluster, and may communicate with and provide services externally. FIG. 3F illustrates the system 300 at this stage. As illustrated by arrow 334 in FIG. 3F, the first partition is operating as an operational online cluster.

Another example of the bifurcated initialization of the first partition described herein relates to a resource group manager subsystem. Briefly, a resource group manager manages applications that may migrate or are distributed among nodes of a cluster. In one example implementation, during the early initialization, a resource group manager may perform calculations related to resources, and determine nodes on which resources are to be activated. In the late initialization, the resource group manager may activate the resources as previously determined.

It is to be noted that in FIG. 3F, components 314c-d and 316c-d of respective nodes C-D 302c-d, contain the symbol “X,” indicating that these components have not yet been updated. Process 400 may flow to block 422, where updating of partition two nodes C-D 302c-d is performed. As discussed with respect to the first partition, this may include automatic updating or manual updating of instructions or data, transforming data formats, contents, or the like.

Process 400 may flow to block 424, where actions are performed to enable partition two nodes to join the cluster of partition one. These actions may include setting a communication token, for example incrementing a communication version number, to enable the partition two nodes to communicate with partition one nodes. The actions may include modifying a mechanism of quorum voting to enable the partition two nodes to become members of the partition one cluster.

The process may flow to block 426, where each partition two node is booted and brought into the partition one cluster. In one embodiment, actions of dividing resources or components into a late and early group, or other actions to block the booting sequence, as described herein, are not performed for the second partition. As each node completes its booting sequence, it may join the existing cluster in a manner similar to a node recovering after failure. Once the nodes of the second partition have joined with the first partition nodes to form a single cluster, the system may automatically restore quorum settings to a configuration similar to the configuration prior to beginning the update process 400.

FIG. 3G illustrates a system 300 after all of the nodes have been updated and formed into a single operational online cluster. The similarity with the system shown in FIG. 3A is to be noted, with the only illustrated difference being the change in version of components 314a-d and 316a-d from version “X” to version “Y.” The process 400 may then flow to a done block, or return to a calling program.

### Illustrative Cluster Node Device

FIG. 5 shows a cluster node device, according to one embodiment of the invention. Cluster node device 500 might include many more or less components than those shown. The components shown, however, are sufficient to disclose an illustrative embodiment for practicing one or more embodiments of the invention. Cluster node device 500 might represent nodes 104, 106, or 108 of FIG. 1, system 200 of FIG. 2, or nodes 302a-d of FIGS. 3A-G.

Cluster node device 500 includes processing unit 512, video display adapter 514, and a mass memory, all in communication with each other via bus 522. The mass memory generally includes RAM 516, ROM 532, and one or more permanent mass storage devices, such as hard disk drive 528, tape drive, optical drive, and/or floppy disk drive. The mass memory stores operating system 520 for controlling the operation of cluster node device 500. The mass memory also stores cluster operating system 550. Cluster operating system 550 may be tightly integrated with operating system 520, or more loosely integrated. In one embodiment, cluster node device 500 may include more than one cluster operating system, each corresponding to a cluster framework, and each controlling resources associated with its cluster framework. Cluster node device 500 also includes additional software programs or components, which might be expressed as one or more executable instructions stored at one or more locations within RAM 516, although the instructions could be stored elsewhere. The software programs or components may include resources 554, update manager 556, applications 558, and associated supporting components. The software programs or components may include additional applications that are managed by the cluster framework or that use the cluster framework.

Each software component, including operating system 520, cluster operating system 550, resources 554, update manager 556, and applications 558, may be implemented in a number of ways, including a variety of architectures. All, or a portion of, each component may be combined with any other component. Although each component is referred to as an individual component, it is to be understood that in some implementations these may be functional components and instructions or data that implement any component may be combined with instructions or data of any other component, or that different components may share instructions or subcomponents.

As illustrated in FIG. 5, cluster node device 500 also can communicate with the Internet, or some other communications network via network interface unit 510, which is constructed for use with various communication protocols including the TCP/IP protocol. Network interface unit 510 is sometimes known as a transceiver, transceiving device, or network interface card (NIC).

The mass memory 516, 526, 528, 532 described herein and shown in FIG. 5 illustrates another type of computer-readable media, namely computer storage media. Computer storage media might include volatile, nonvolatile, removable, and non-removable media implemented in any method or technology for storage of information, such as computer readable instructions, data structures, program modules, or other data, which might be obtained and/or executed by CPU 512 to perform one or more portions of process 400 shown in FIG. 4A-B, for example. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory might also store other types of program code and data as software programs or components, which might be loaded into mass memory and run on operating system 520. Examples of application 558 might include email client/server programs, routing programs, schedulers, calendars, database programs, word processing programs, HTTP programs, RTSP programs, traffic management programs, security programs, and any other type of application program.

Cluster node device 500 might also include an SMTP handler application for transmitting and receiving e-mail, an HTTP handler application for receiving and handing HTTP requests, a RTSP handler application for receiving and handing RTSP requests, and an HTTPS handler application for handling secure connections. The HTTPS handler application might initiate communication with an external application in a secure fashion. Moreover, cluster node device 500 might further include applications that support virtually any secure connection, including TLS, TTLS, EAP, SSL, IPSec, or the like.

Cluster node device 500 might also include input/output interface 524 for communicating with external devices, such as a mouse, keyboard, scanner, or other input/output devices not shown in FIG. 5. Likewise, cluster node device 500 might further include additional mass storage facilities, such as CD-ROM/DVD-ROM drive 526 and hard disk drive 528. Hard disk drive 528 might be utilized to store, among other things, application programs, databases, or the like in the same manner as the other mass memory components described above.

It will be understood that each block of the flowchart illustrations of FIGS. 4A-B, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented method such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustrations may also be performed concurrently with other blocks or combinations of blocks, or even in a different sequence than illustrated, unless clearly stated otherwise, without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustrations, and combinations of blocks in the flowchart illustrations, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method of updating a cluster of nodes, comprising:
a) taking offline a first partition of nodes of the cluster of nodes;
b) updating software on each node of the first partition;
c) performing a partial initialization of each node of the first partition;
d) after performing the partial initialization of each node of the first partition, taking offline a second partition of nodes of the cluster of nodes;
e) after taking offline the second partition of nodes, performing an additional initialization of each node of the first partition;
f) bringing the first partition of nodes online;
g) updating software on each node of the second partition; and
h) bringing the second partition of nodes online.

2. The method of claim 1, wherein performing additional initialization comprises mounting a file system or advertising an IP address.

3. The method of claim 1, wherein performing additional initialization comprises importing one or more storage volumes.

4. The method of claim 1, further comprising forming a cluster of nodes of the first partition of nodes, and selectively allowing the cluster of nodes of the first partition of nodes to communicate with the second partition of nodes based on whether the second partition of nodes has been updated.

5. The method of claim 1, further comprising modifying quorum configuration data to enable forming a cluster of the first partition of nodes.

6. The method of claim 1, further comprising forming an offline cluster of the first partition of nodes prior to taking offline the second partition of nodes.

7. The method of claim 1, wherein updating software on each node comprises updating at least one of operating system software, file system software, volume manager software, cluster software, or application software.

8. The method of claim 1, wherein performing a partial initialization comprises discovering a substantial portion of devices that are connected to each node of the first partition.

9. The method of claim 1, further comprising establishing membership of nodes of the first partition prior to taking offline the second partition of nodes.

10. A system for updating a cluster of nodes, comprising:
a) a cluster operating system;
b) means for updating a first version of software on a first partition of the cluster nodes to a second version of the software and forming an offline cluster of the first partition concurrently with a cluster of a second partition of the cluster of nodes employing the first version of the software and remaining online;
c) means for preventing the first version of the software from being employed by the cluster concurrently with the second version of the software being employed by the cluster.

11. The system of claim 10, wherein the means for updating the first version partially initializes components on each of the first partition nodes prior to forming the offline cluster and performs additional initialization on each of the first partition nodes after bringing a second partition of the cluster nodes offline.

12. The system of claim 10, wherein the means for updating the first version mounts a file system after forming the offline cluster.

13. The system of claim 10, wherein the means for updating determines an association between resources and nodes of the first partition prior to bringing a second partition of the cluster nodes offline.

14. The system of claim 10, further comprising a means for scheduling the initializing of components on each node of the first partition to enable forming the offline cluster prior to bringing the second partition offline.

15. A processor readable medium that includes data, wherein the execution of the data provides for updating a cluster of nodes by enabling actions, including:
a) taking offline a first partition of nodes of the cluster of nodes;
b) updating software on each node of the first partition from a first version to a second version;
c) forming a cluster of the first partition of nodes;
d) after forming the cluster of the first partition of nodes, bringing a second partition of nodes of the cluster offline; and
f) bringing online the cluster of the first partition of nodes;

16. The processor readable medium of claim 15, the actions further comprising selectively mounting a file system on a node of the first partition based on whether the second partition of nodes is offline.

17. The processor readable medium of claim 15, the actions further comprising selectively advertising an IP address of the first partition based on whether the second partition is offline.

18. The processor readable medium of claim 15, the actions further comprising modifying quorum configuration data to enable forming the cluster of the first partition concurrently with the second partition of nodes remaining online.

19. The processor readable medium of claim 15, the actions further comprising, prior to bringing the second partition of nodes of the cluster offline, initializing a set of components of the first partition of nodes, the set based on whether the components access an external shared resource.

20. The processor readable medium of claim 15, the actions further comprising modifying quorum voting configuration to enable forming the cluster of the first partition of nodes concurrently with the second partition of nodes remaining online.

21. The processor readable medium of claim 15, the actions further comprising disabling fencing to allow one or more nodes of the first partition to access an external device.
